(19) United States
(12) Patent Application Publication
(10) Pub. No.: US 2009/0097420 A1
(43) Pub. Date: Apr. 16, 2009

(54) METHOD AND SYSTEM FOR LAWFUL INTERCEPTION OF VALUE-ADDED SERVICE IN IP MULTIMEDIA SUBSYSTEM

(75) Inventors: Wei-Kuo Chiang, Chiayi County (TW); Pei-An Lee, Taichung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 11/969,224

(22) Filed: Jan. 4, 2008

(30) Foreign Application Priority Data
Oct. 15, 2007 (TW) 96138497

(51) Int. Cl. H04L 12/16

(52) U.S. Cl. 370/259

(57) ABSTRACT

A method and a system for lawfully intercepting a value-added service in an IP multimedia subsystem (IMS) are provided. In the present method, a service subscription information is sent to a first information delivery module when a suspect is registered to an IMS network. A service triggering information is sent to the first information delivery module when the value-added service subscribed by the suspect is triggered. Furthermore, when the value-added service is provided, an intercept related information (IRI) is sent to the first information delivery module according to the characteristics of the value-added service. As a result, the suspect who is using the value-added service in the IMS can be lawfully intercepted according to the information collected by the first information delivery module.

### CROSS-REFERENCE TO RELATED APPLICATION

This application claims the priority benefit of Taiwan application serial no. 96138497, filed on Oct. 15, 2007. The entirety of the above-mentioned patent application is hereby incorporated by reference herein and made a part of this specification.

### BACKGROUND OF THE INVENTION

1. Field of the Invention

The present invention generally relates to a method and a system for lawful interception, in particular, to a method and a system for lawfully intercepting a value-added service in an IP multimedia subsystem (IMS).

2. Description of Background Art

Through the lawful interception architecture specified by the 3rd Generation Partnership Project (3GPP), a law enforcement agency can collect the communication data of criminals with the assistance of a telecommunication service provider.

FIG. 1 is a diagram of the existing lawful interception architecture specified by 3GPP. Referring to FIG. 1, a lawful interception system 100 composed of a home subscriber server (HSS) module 110, a call session control function (CS CF) module 120, a GPRS support node (GSN) module 101, a delivery function 2 (DF2) module 130, and a delivery function 3 (DF3) module 140 is disposed by a telecommunication service provider and used by a law enforcement agency for collecting interception data.

In a basic operation procedure of lawful interception, the law enforcement agency issues an interception instruction to an administration function (ADMF) module (not shown) provided by the telecommunication service provider via a law enforcement monitoring facilities (LEMF) module 150. Next, the ADMF module requests interception data of a suspect from various monitoring modules in the lawful interception system 100. Under the lawful interception architecture, each module has to communicate with another module through an interface specified by 3GPP. Accordingly, the HSS module 110, the CSCF module 120, and the GSN module 101 send intercept related information (IRI) of the suspect to the DF2 module 130 through X2 interfaces. In addition, the GSN module 101 sends the content of communication (CC) of the suspect to the DF3 module 140 through an X3 interface. The DF2 module 130 and the DF3 module 140 respectively send the IRI and the CC to the LEMF module 150 through a handover interface 2 (HI 2) and a handover interface 3 (HI 3) to intercept the conversation of the suspect.

However, the existing lawful interception architecture does not support the interception of various value-added services provided by an IP multimedia subsystem (IMS). Thus, the law enforcement agency can only perform lawful interception to suspects using the basic communication service due to the limitation of the lawful interception system 100.

### SUMMARY OF THE INVENTION

Accordingly, the present invention is directed to a lawful interception method for a value-added service in an IP multimedia subsystem (IMS), wherein users using the value-added service in the IMS can be lawfully intercepted.

The present invention is directed to a lawful interception system for a value-added service in an IMS, wherein the existing lawful interception architecture is improved so that related information of a suspect using the value-added service in the IMS can be provided.

An exemplary example of the present invention provides a lawful interception method for a value-added service in an IMS, wherein a suspect registered to an IMS network can be lawfully intercepted. In the present method, a service subscription information of the suspect is sent to a first information delivery module. A service triggering information is sent to the first information delivery module when the value-added service subscribed by the suspect is triggered. When the value-added service is provided, an intercept related information (IRI) is sent to the first information delivery module according to the characteristics of the value-added service. As a result, the suspect can be intercepted according to the information collected by the first information delivery module.

An exemplary example of the present invention also provides a lawful interception system for a value-added service in an IMS. The system includes a first information delivery module, a first monitoring module, a second monitoring module, and a third monitoring module. The first information delivery module collects the information of a suspect and providing the information to a law enforcement monitoring facilities (LEMF) module to perform a lawful interception. The first monitoring module sends a service subscription information of the suspect to the first information delivery module when the suspect is registered to an IMS network. The second monitoring module sends a service triggering information to the first information delivery module when the value-added service subscribed by the suspect is triggered. The third monitoring module provides the value-added service subscribed by the suspect and at the same time, sends an IRI to the first information delivery module according to the characteristics of the value-added service.

According to an exemplary example of the present invention, an application server (AS) module for providing a value-added service is added to the existing lawful interception architecture, and the operations of the original monitoring modules are revised, so that when a suspect is using the value-added service, related information and the content of communication (CC) can be provided by the monitoring modules and the AS modules in the system and accordingly the value-added service can be lawfully intercepted.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a diagram of an existing lawful interception architecture specified by 3GPP.

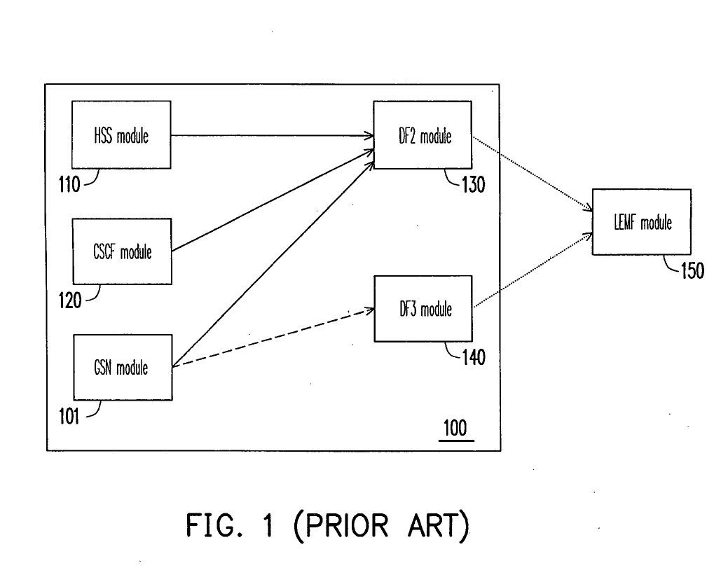

FIG. 2 is a diagram of a system for lawfully intercepting a value-added service in an IP multimedia subsystem (IMS) according to an exemplary embodiment of the present invention.

FIG. 3 is a flowchart of a method for lawfully intercepting a value-added service in an IMS according to an exemplary embodiment of the present invention.

FIG. 4 is a diagram of a system for lawfully intercepting a push-to-talk over cellular (PoC) service according to an exemplary embodiment of the present invention.

FIG. 5 is a flowchart of a method for lawfully intercepting a PoC service according to an exemplary embodiment of the present invention.

### DESCRIPTION OF THE EMBODIMENTS

Reference will now be made in detail to the exemplary embodiments of the invention, examples of which are illustrated in the accompanying drawings. Wherever possible, the same reference numbers are used in the drawings and the description to refer to the same or like parts.

Along with the coming of IP multimedia subsystem (IMS) era, various value-added services are provided to users besides the basic communication service. However, a suspect using a value-added service in an IMS cannot be intercepted with existing lawful interception architecture. As a result, the reliability of the entire interception system is reduced and the collected interception data becomes incomplete. The integrity of an interception system can be improved if all the information related to a value-added service in an IMS can be collected. The present invention provides a method and a system for lawfully intercepting a value-added service in an IMS. Exemplary embodiments of the present invention will be described below with reference to accompanying drawings.

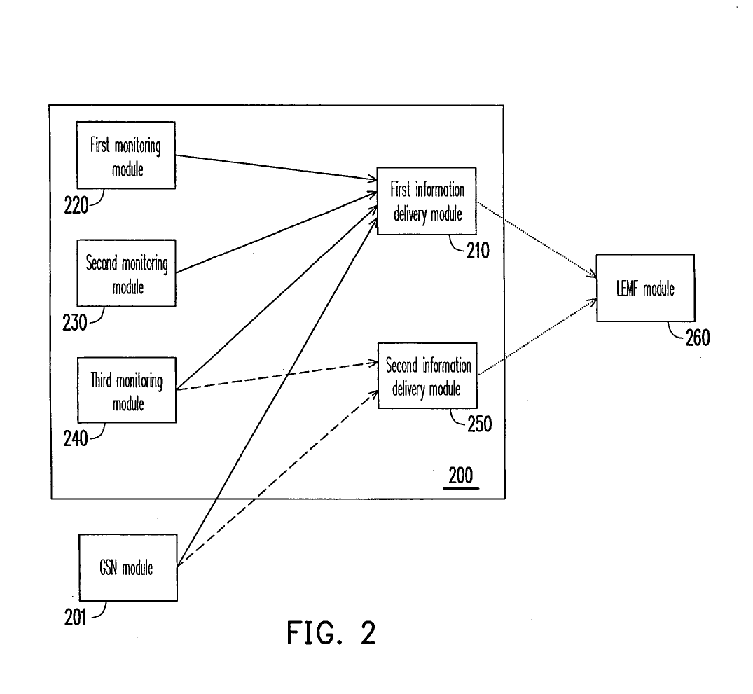

FIG. 2 is a diagram of a lawful interception system for a value-added service in an IMS according to an exemplary embodiment of the present invention. Referring to FIG. 2, a law enforcement agency issues an interception instruction to an administration function (ADMF) module (not shown) via a law enforcement monitoring facilities (LEMF) module 260. Next, the ADMF module requests the related modules of the lawful interception system 200 to collect all the interception information related to the value-added service and sends the collected interception information back to the LEMF module 260. Accordingly, any suspect who is registered to the IMS network via a GPRS support node (GSN) module 201 and uses the value-added service can be lawfully intercepted by a law enforcement agency. The lawful interception system 200 includes a first monitoring module 220, a second monitoring module 230, a third monitoring module 240, a first information delivery module 210, and a second information delivery module 250. The functions of foregoing modules will be described below.

In the exemplary embodiment, the first monitoring module 220 may be a home subscriber server (HSS) module. According to the specification in appendix B of 3GPP TS 29.228, a user profile stored in a HSS module includes an initial filter criteria (iFC) for recording the value-added service subscribed by the suspect and the address of an application server (AS) which provides the value-added service. In order to intercept the value-added service, the first monitoring module 220 sends a service subscription information corresponding to the suspect to the first information delivery module 210, wherein the service subscription information contains the name of the value-added service subscribed by the suspect and the address of an AS which provides the value-added service.

The second monitoring module 230 may be a call session control function (CSCF) module for sending a service triggering information to the first information delivery module 210, wherein the service triggering information contains the name of the value-added service to be triggered, the triggering time, and a uniform resource identifier (URI) of the AS which provides the service. A law enforcement agency can get to know which value-added service the intercepted suspect is using at a particular time point based on the content of the service triggering information.

The third monitoring module 240 may be an AS module for providing the value-added service subscribed by the suspect and sending an intercept related information (IRI) to the first information delivery module 210 according to the characteristics of the value-added service. In an exemplary embodiment of the present invention, the IRI contains the name of the value-added service; while in another exemplary embodiment of the present invention, the IRI further contains at least one of the address of a multimedia server, the address of a database, the address of the AS, or service related information of the value-added service. The service related information may be predetermined by a service provider of the value-added service, and different value-added services have different service related information. In addition, the third monitoring module 240 also sends the content of communication (CC) containing media data to the second information delivery module 250 when the value-added service provided by the third monitoring module 240 needs to transmit media data (for example, services that need to transmit content of conversation and audio/video file, or services that need to download data from the Internet).

In the exemplary embodiment, the first monitoring module 220, the second monitoring module 230, and the third monitoring module 240 send the related information of the value-added service to the first information delivery module 210 through X2 interfaces, and the third monitoring module 240 sends the CC to the second information delivery module 250 through an X3 interface. After receiving the interception data related to the value-added service used by the suspect, the first information delivery module 210 and/or the second information delivery module 250 send the interception data to the LEMF module 260 so that the LEMF module 260 can lawfully intercept the value-added service.

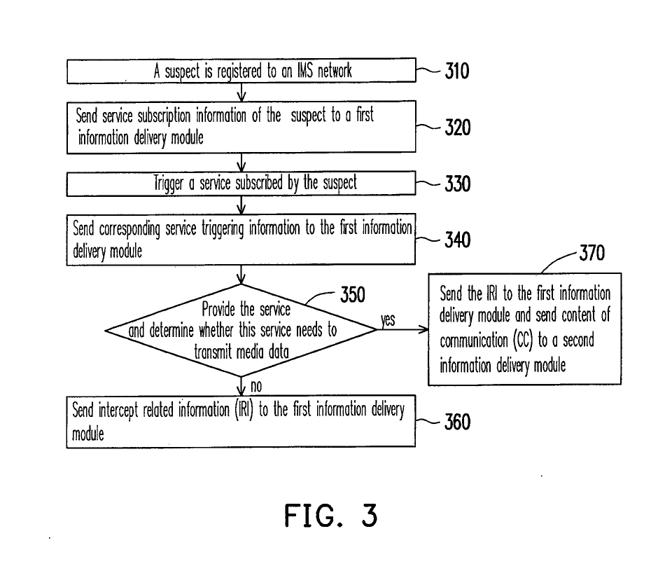

Another exemplary embodiment of the present invention will be described below in order to explain the method for lawfully intercepting a value-added service by using the lawful interception system 200. FIG. 3 is a flowchart of the lawful interception method for a value-added service in an IMS according to the exemplary embodiment. Referring to both FIG. 2 and FIG. 3, first, in step 310, a suspect is connected to a packet switch (PS) network by performing a PS attach procedure through the connection between the GSN module 201 and an access point (AP), and a corresponding packet data protocol context (PDP context) is established in order to obtain an Internet protocol (IP) address and accordingly register the suspect to an IMS network.

After the suspect is registered to the IMS network, the first monitoring module 220 sends the service subscription information of the suspect to the first information delivery module 210 in step 320. In the exemplary embodiment, the first monitoring module 220 also sends the service subscription information instantly to the first information delivery module 210 when the suspect adds or deletes the value-added service, so as to ensure that the LEMF module 260 can intercept all the value-added services subscribed by the suspect through the lawful interception system 200.

Next, in step 330, when the suspect is about to use the value-added service, the second monitoring module 230 downloads an iFC corresponding to the suspect from the first monitoring module 220 and determines whether the value-added service conforms to the iFC. If the value-added service conforms to the iFC, which means the suspect has subscribed this service, the second monitoring module 230 triggers the service. In step 340, the second monitoring module 230 sends a service triggering information to the first information delivery module 210 at the same time when it triggers the value-added service.

It should be mentioned that value-added services suitable for a IMS network include services which transmit only signals and services which transmit both signals and media data. For example, value-added services which transmit only signals include instant messaging service, presence service, extensible markup language (XML) document management service, or group list management service etc, while value-added services which transmit both signals and media data include game service, push-to-talk over cellular (PoC) service, multimedia conference service, and multimedia messaging service etc. The interception data to be delivered varies by the type of the value-added service. Thus, in step 350, the third monitoring module 240 determines whether the value-added service needs to transmit media data according to the type of the value-added service after the third monitoring module 240 has started to provide the value-added service.

If the value-added service does not need to transmit media data, the third monitoring module 240 sends an IRI to the first information delivery module 210 in step 360. However, if the value-added service needs to transmit both signals and media data, then in step 370, the third monitoring module 240 also sends the CC (for example, content of conversation, downloaded audio/video data or files etc) to the second information delivery module 250 besides sending the IRI to the first information delivery module 210.

In the exemplary embodiment, because the third monitoring module 240 respectively sends the IRI and the CC to the first information delivery module 210 and the second information delivery module 250, a correlation number is further included in the IRI for indicating the mapping between the IRI and the CC.

In the exemplary embodiment described above, the information related to the value-added service is collected by the first information delivery module 210, and the CC is collected by the second information delivery module 250. Thereby, the LEMF module 260 can perform a lawful interception to the suspect according to the interception data received from the first information delivery module 210 and the second information delivery module 250 regardless of which kind of value-added service the suspect uses.

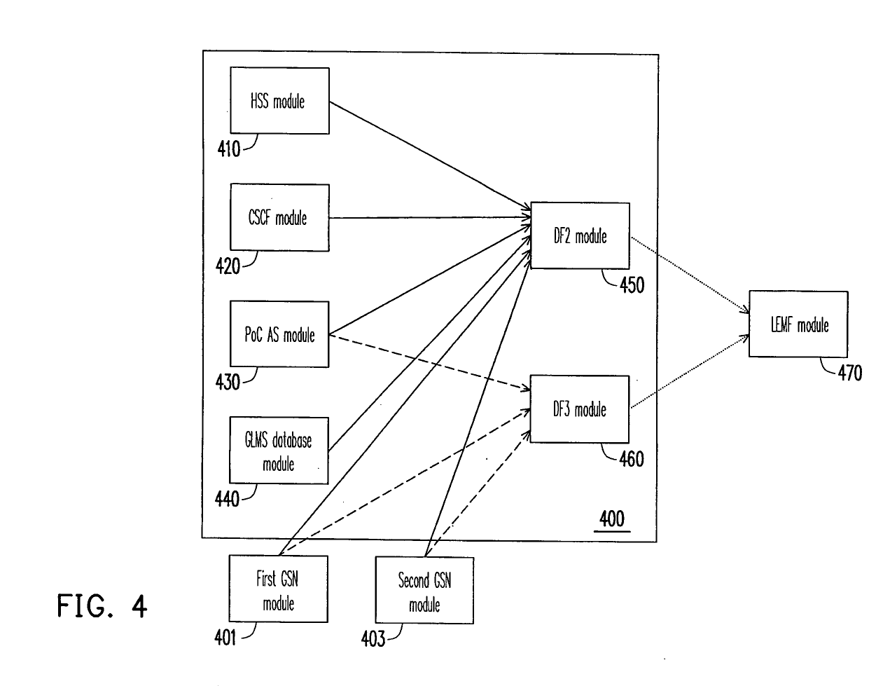

In following exemplary embodiment, a method and a system for lawfully intercepting a suspect using a PoC service will be described. FIG. 4 is a diagram of the lawful interception system for a PoC service according to an exemplary embodiment of the present invention. Referring to FIG. 4, in the exemplary embodiment, it is assumed that a suspect A, a user B, and a user C all subscribe to a PoC service provided by a PoC AS module 430, and the suspect A, user B, and user C all belong to the same CSCF module 420, but the GSN module of user B and user C is different from the GSN module of suspect A. In other words, suspect A is registered to the IMS network through a first GSN module 401, while user B and user C are registered to the IMS network through a second GSN module 403. It should be mentioned that the lawful interception system 400 further includes a group list management server (GLMS) database module 440 for storing a group list set by suspect A. While using the PoC service, suspect A obtains the group list from the GLMS database module 440 and performs PoC conversation with members in the group list.

In the exemplary embodiment, a delivery function 2 (DF2) module 450 serves as the first information delivery module, and a delivery function 3 (DF3) module 460 serves as the second information delivery module. Accordingly, the HSS module 410, the CSCF module 420, the PoC AS module 430, and the GLMS database module 440 send the information related to the PoC service to the DF2 module 450, and the PoC AS module 430 sends the CC of the PoC service to the DF3 module 460, so that all the interception data related to the PoC service is provided to the LEMF module 470.

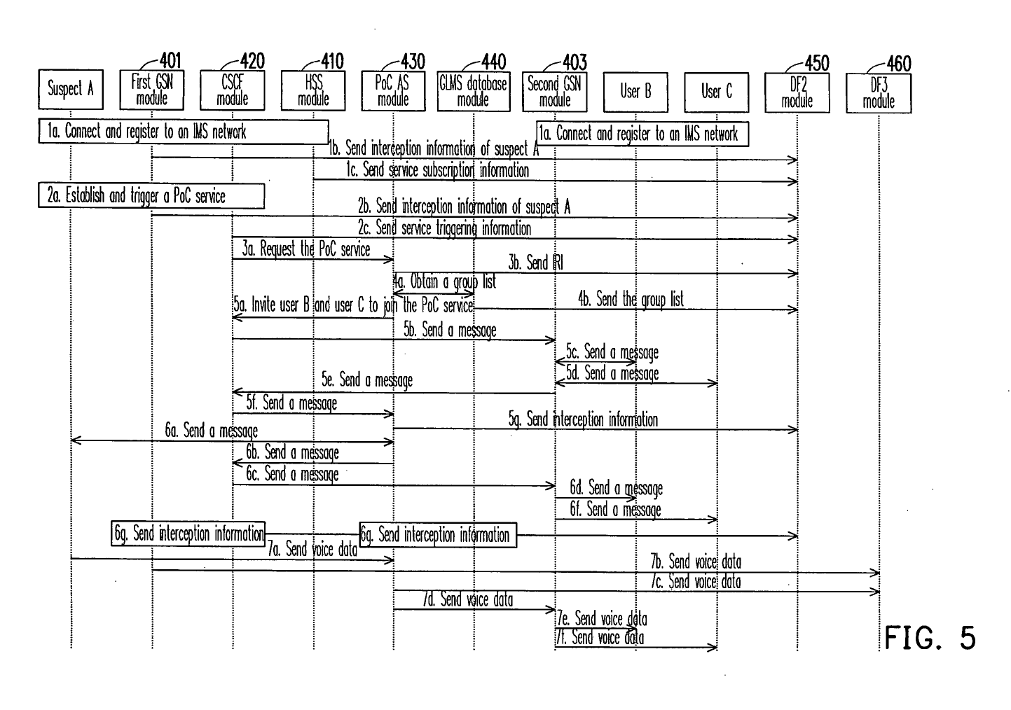

FIG. 5 is a flowchart of a method for lawfully intercepting a suspect using a PoC service according to an exemplary embodiment of the present invention. Referring to FIG. 5, assuming suspect A is intercepted, suspect A, user B, and user C are registered to an IMS network in step 1a. Because the suspect A is intercepted, the first GSN module 401 sends the interception data related to suspect A to the DF2 module 450 in step 1b. In step 1c, after the suspect A is registered to the IMS network, the HSS module 410 sends the service subscription information (including the names of various services subscribed by suspect A and addresses of ASs for providing these services) to the DF2 module 450.

When the suspect A decides to use the PoC service, in step 2a, an INVITE message specified according to the session initiation protocol (SIP) is sent to the CSCF module 420 so that the CSCF module 420 compares the PoC service and the iFC stored in the HSS module 410 in order to trigger the PoC service. In step 2b, the first GSN module 401 needs to send the interception information of suspect A to the DF2 module 450 according to the specification of the lawful interception architecture. In step 2c, the CSCF module 420 sends the service triggering information to the DF2 module 450, wherein the service triggering information contains the triggering time of the service, the name of the service, and the URI of the corresponding AS etc.

Next, in step 3a, the CSCF module 420 sends the INVITE message to the PoC AS module 430 and requests the PoC AS module 430 to provide the PoC service. In step 3b, after receiving the INVITE message, the PoC AS module 430 sends the IRI to the DF2 module 450. In the exemplary embodiment, the IRI contains the name of the service, the URI address of a related database (for example, the GLMS database), and related messages of the PoC service etc.

Thereafter, in steps 4a and 4b, after receiving the INVITE message, the PoC AS module 430 requests the group list set by suspect A from the GLMS database module 440. When the GLMS database module 440 receives this request, it sends the group list to both the PoC AS module 430 and the DF2 module 450.

The PoC AS module 430 gets to know that user B and user C are group members set by suspect A based on the group list, and then in steps 5a-5f, the PoC AS module 430 requests user B and user C to join the PoC service by sending the INVITE message to user B and user C. User B and user C respectively send a 200 OK message to the PoC AS module 430 if they agree to join the PoC conversation. After receiving the 200 OK messages, the PoC AS module 430 provides the interception information to the DF2 module 450 in step 5g.

Next, in steps 6a-6f, the PoC AS module 430 notifies the suspect A that the user B and the user C have joined the conversation by sending a 200 OK message, and sends an ACK message issued by the suspect A to the user B and the user C. After that, voice transmission is carried out. In step 6g, the first GSN module 401, the CSCF module 420, and the PoC AS module 430 sends the interception information to the DF2 module 450 after they send the 200 OK message or ACK message.

Once the PoC conversation is started, the suspect A establishes a connection for media data and sends a voice data in step 7a. Next, in steps 7b and 7c, the first GSN module 401 collects voice data (i.e. the CC) and sends the voice data to the DF3 module 460, and the PoC AS module 430 collects the CC and sends the CC also to the DF3 module 460. Finally, in steps 7d-7f, the PoC AS module 430 sends the voice data to the users B and C via the second GSN module 403 so as to complete the PoC conversation.

Related data and CC of the PoC service can be obtained through the HSS module 410, the CSCF module 420, the PoC AS module 430, and the GLMS database module 440 in the lawful interception system 400. Furthermore, a group list set by the suspect can be obtained from the GLMS database module 440, and after receiving foregoing information, the LEMF module 470 can performs a dynamic interception according to the group members in the group list. In foregoing exemplary embodiment, the user B and the user C may belong to the same criminal group as the suspect A since they are included in the group list set by the suspect A. Through foregoing lawful interception system 400 of a value-added service in an IMS, the LEMF module 470 can issue a lawful interception instruction regarding user B and user C to the ADMF module (not shown), and complete interception information and CC of the PoC service can be collected.

In summary, in the lawful interception method and system described in foregoing exemplary embodiments, an AS module for providing a value-added service is added to the existing lawful interception architecture, and the original monitoring modules such as the HSS module and the CSCF module are also revised appropriately. As a result, a lawful interception can be performed to a suspect who is using a value-added service in an IMS, so that the existing interception architecture is made more complete and the integrity of lawful interception is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A lawful interception method for a value-added service in an IP multimedia subsystem (IMS), for intercepting a suspect registered to an IMS network, the lawful interception method comprising:
sending a service subscription information of the suspect to a first information delivery module;
sending a service triggering information to the first information delivery module when the value-added service subscribed by the suspect is triggered;
sending an intercept related information (IRI) to the first information delivery module according to the characteristics of the value-added service when the value-added service is provided; and
intercepting the suspect according to the information collected by the first information delivery module.

2. The lawful interception method according to claim 1, wherein before sending the service subscription information to the first information delivery module, the lawful interception method further comprises:
performing a PS attach procedure to connect the suspect to a packet switch (PS) network;
establishing a corresponding packet data protocol (PDP) context; and
performing an IMS network registration procedure.

3. The lawful interception method according to claim 1, wherein the service subscription information comprises a name of the value-added service and an address of an application server (AS) providing the value-added service.

4. The lawful interception method according to claim 1 further comprising:
downloading an initial filter criteria (iFC);
determining whether the value-added service subscribed by the suspect conforms to the iFC when the value-added service is to be triggered; and
triggering the value-added service if the value-added service conforms to the iFC.

5. The lawful interception method according to claim 1, wherein the service triggering information comprises a name of the value-added service and a uniform resource identifier (URI) of an AS providing the value-added service.

6. The lawful interception method according to claim 1, wherein the IRI comprises a name of the value-added service.

7. The lawful interception method according to claim 1, wherein the IRI comprises at least one of an address of a multimedia server, an address of a database, and an address of an AS, and an information related to the value-added service.

8. The lawful interception method according to claim 1, further comprising:
sending the service subscription information to the first information delivery module when the suspect adds or deletes the value-added service.

9. The lawful interception method according to claim 1, wherein when the value-added service is provided, the lawful interception method further comprises:
sending a content of communication (CC) to a second information delivery module; and
intercepting the suspect according to the information collected by the second information delivery module.

10. The lawful interception method according to claim 9, wherein the IRI comprises a correlation number for indicating a mapping between the IRI and the CC.

11. The lawful interception method according to claim 1, wherein when the service is provided, the lawful interception method further comprises:
obtaining a group list corresponding to the value-added service, wherein the group list is set by the suspect and comprises at least one group member;
sending the group list to the first information delivery module; and
providing the value-added service to the group member.

12. A lawful interception system for a value-added service in an IMS, comprising:
a first information delivery module, for collecting the information of a suspect and providing the information to a law enforcement monitoring facilities (LEMF) module to perform a lawful interception;
a first monitoring module, for sending a service subscription information of the suspect to the first information delivery module when the suspect is registered to an IMS network;
a second monitoring module, for sending a service triggering information to the first information delivery module when the value-added service subscribed by the suspect is triggered; and
a third monitoring module, for providing the value-added service subscribed by the suspect and, at the time when the value-added service is provided, sending an IRI to the first information delivery module according to the characteristics of the value-added service.

13. The lawful interception system according to claim 12, wherein the first monitoring module, the second monitoring module, and the third monitoring module send information to the first information delivery module through X2 interfaces.

14. The lawful interception system according to claim 12, wherein the service subscription information comprises a name of the value-added service and an address of an AS providing the value-added service.

15. The lawful interception system according to claim 12, wherein the first monitoring module further stores an iFC, the second monitoring module downloads the iFC from the first monitoring module and determines whether the value-added service subscribed by the suspect conforms to the iFC when the value-added service is to be triggered, and the second monitoring module triggers the value-added service if the value-added service conforms to the iFC.

16. The lawful interception system according to claim 12, wherein the service triggering information comprises a name of the value-added service and an URI of an AS providing the value-added service.

17. The lawful interception system according to claim 12, wherein the IRI comprises a name of the value-added service.

18. The lawful interception system according to claim 12, wherein the IRI comprises at least one of an address of a multimedia server, an address of a database, an address of an AS, and an information related to the value-added service.

19. The lawful interception system according to claim 12, wherein the first monitoring module further sends the service subscription information to the first information delivery module when the suspect adds or deletes the value-added service.

20. The lawful interception system according to claim 12, further comprising:
a second information delivery module, for collecting information of the suspect and providing the information to the LEMF module to perform a lawful interception;
wherein the third monitoring module further sends a CC to the second information delivery module when the value-added service is provided.

21. The lawful interception system according to claim 20, wherein the IRI comprises a correlation number for indicating a mapping between the IRI and the CC.

22. The lawful interception system according to claim 20, wherein the third monitoring module sends the CC to the second information delivery module through an X3 interface.

23. The lawful interception system according to claim 12, further comprising:
a database module, for storing a group list corresponding to the value-added service, wherein the group list is set by the suspect and comprises at least one group member;
wherein when the value-added service is provided, the third monitoring module obtains the group list from the database module and provides the value-added service to the group member, and the database module sends the group list to the first information delivery module.

24. The lawful interception system according to claim 12, wherein the first monitoring module comprises a home subscriber server (HSS) module, the second monitoring module comprises a call session control function (CSCF) module, and the third monitoring module comprises an AS module.
